(19) United States
(12) Patent Application Publication
(10) Pub. No.: US 2017/0255733 A1
(43) Pub. Date: Sep. 7, 2017

(54) DESIGN SUPPORT DEVICE, DESIGN SUPPORT METHOD, AND NON-TRANSITORY COMPUTER READABLE RECORDING MEDIUM RECORDED WITH DESIGN SUPPORT PROGRAM

(71) Applicant: Mitsubishi Electric Corporation, Tokyo (JP)

(72) Inventors: Fumitoshi KARUBE, Tokyo (JP); Ryo YAMAMOTO, Tokyo (JP); Yoshihiro OGAWA, Tokyo (JP)

(73) Assignee: Mitsubishi Electric Corporation, Tokyo (JP)

(21) Appl. No.: 15/237,292

(22) Filed: Aug. 15, 2016

(30) Foreign Application Priority Data
Mar. 4, 2016 (JP) 2016-042514

(51) Int. Cl. G06F 17/50

(52) U.S. Cl. CPC G06F 17/5045; G06F 17/5031

(57) ABSTRACT

To provide a design support device capable of analyzing a source code described in a high-order language and extracting an operation expression where latency can be effectively reduced through tabulation.

Provided is a design support device including: an analysis unit to extract an operation expression where the number of loops is less than or equal to a number threshold from a source code and to output the extracted operation expression as an extracted operation expression; a latency storage unit to store, as operation expression latency in a storage unit, latency of a converted operation expression converted into a hardware description language from the extracted operation expression output from the analysis unit; and a determination unit to output the extracted operation expression as a determination result when the operation expression latency is more than or equal to a latency threshold.

### CROSS-REFERENCE TO RELATED APPLICATIONS

This application is based on and claims the benefit of priority from Japanese Patent Application No. 2016-042514, filed in Japan on Mar. 4, 2016, the content of which is incorporated herein by reference in its entirety.

### TECHNICAL FIELD

The present invention relates to a design support device, a design support method, and a design support program to support design of a circuit.

### BACKGROUND ART

In designing a semiconductor integrated circuit in the related art, operations of combinational circuits among registers (flip-flop) are described using a hardware description language such as the register transfer level (RTL). In recent years, the size of integrated circuits is increased and thus designing with a hardware description language may require a lot of design time. Therefore, proposed is a technique to perform designing using a high-order language such as the C language, C++ language, or SystemC language having a higher level of abstraction than a hardware description language and to automatically generate the RTL. Furthermore, a tool to implement this is in the commercial market as a high-order synthesis tool.

However, since descriptions in a high-order language do not include accurate time concept, latency of operation processing is not clear until the RTL is generated. Moreover, when the latency of operation processing does not satisfy desired latency, it is desirable to analyze of which processing latency is posing an issue from among a plurality of pieces of operation processing.

Patent Literature 1 describes tabulating an operation result of an operator with an object to shorten simulation time.

### CITATION LIST

### Patent Literature

Patent Literature 1: JP 07-200665 A

### SUMMARY OF INVENTION

### Technical Problem

As described above, the object of Patent Literature 1 is to shorten simulation time and thus has an issue that latency cannot be effectively reduced.

An object of the present invention is to provide a design support device capable of analyzing a source code described in a high-order language and extracting an operation expression where latency can be effectively reduced through tabulation.

### Solution to Problem

A design support device includes:

an analysis unit to extract an operation expression where a number of loops is less than or equal to a number threshold from a source code and to output the operation expression as an extracted operation expression;

a latency storage unit to store, as operation expression latency in a storage unit, latency of a converted operation expression converted into a hardware description language from the extracted operation expression output from the analysis unit; and

a determination unit to output the extracted operation expression as a determination result when the operation expression latency is more than or equal to a latency threshold.

### Advantageous Effects of Invention

In a design support device of the present invention: an analysis unit extracts an operation expression where the number of loops is less than or equal to a number threshold from a source code and outputs the operation expression as an extracted operation expression; a latency storage unit stores, as operation expression latency in a storage unit, latency of a converted operation expression converted into a hardware description language from the extracted operation expression; and a determination unit outputs the extracted operation expression as a determination result when the operation expression latency is more than or equal to a latency threshold. Therefore, an effect of accurately extracting an operation expression suitable for tabulation and having large latency can be achieved.

### BRIEF DESCRIPTION OF DRAWINGS

The present invention will become fully understood from the detailed description given hereinafter in conjunction with the accompanying drawings, in which:

FIG. 1 is a configuration diagram of a design support device 100 of a first embodiment;

FIG. 2 is a flowchart of a design support method 510 of the design support device 100 and design support processing S100 by a design support program 520 of the first embodiment;

FIG. 3 is a flowchart of analysis processing S120 of the first embodiment;

FIG. 4 is a flowchart of latency storing processing S130 of the first embodiment;

FIG. 5 is a flowchart of determination processing S140 of the first embodiment;

FIG. 6 is an example of a source code 180 to be processed by the design support device 100 of the first embodiment;

FIG. 7 is another example of the source code 180 to be processed by the design support device 100 of the first embodiment;

FIG. 8 is a diagram showing a tabulated tabulating operation expression 185 of the first embodiment;

FIG. 9 is an exemplary pragma description when the tabulating operation expression 185 of the first embodiment is tabulated;

FIG. 10 is a configuration diagram of a design support device 100x of a variation of the first embodiment.

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

### First Embodiment

### ***Description of Configuration***

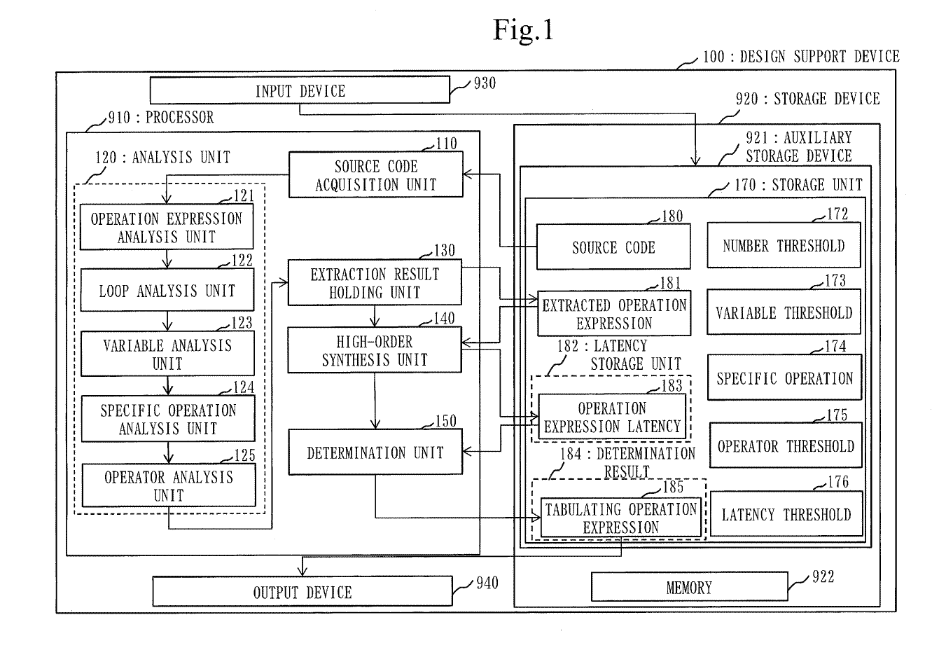

A configuration of a design support device 100 of the present embodiment will be described with FIG. 1. In the present embodiment, the design support device 100 is a computer. The design support device 100 includes hardware including a processor 910, storage device 920, input device 930, and output device 940. The storage device 920 includes an auxiliary storage device 921 and memory 922.

The design support device 100 includes, as functional configurations, a source code acquisition unit 110, analysis unit 120, extraction result holding unit 130, high-order synthesis unit 140, determination unit 150, and storage unit 170. The analysis unit 120 includes an operation expression analysis unit 121, loop analysis unit 122, variable analysis unit 123, specific operation analysis unit 124, and operator analysis unit 125. In the descriptions below, functions of the source code acquisition unit 110, analysis unit 120, extraction result holding unit 130, high-order synthesis unit 140, and determination unit 150 of the design support device 100 are referred to as functions of the “units” of the design support device 100. The function of the analysis unit 120 includes functions of the operation expression analysis unit 121, loop analysis unit 122, variable analysis unit 123, specific operation analysis unit 124, and operator analysis unit 125. The functions of the “units” of the design support device 100 are implemented by software.

Moreover, the storage unit 170 is implemented by the storage device 920. The storage unit 170 stores a number threshold 172, variable threshold 173, specific operation 174, operator threshold 175, and latency threshold 176 that have been input in advance via the input device 930. The storage unit 170 further stores a source code 180, extracted operation expression 181, operation expression latency 183, and tabulating operation expression 185. The operation expression latency 183 is stored in the storage unit 170 by a latency storage unit 182. The storage unit 170 stores RTL or the like in addition to the above.

The processor 910 is connected to other hardware via a signal line and thereby controls the other hardware. The processor 910 is an integrated circuit (IC) that performs processing. The processor 910 may specifically be a central processing unit (CPU).

The storage device 920 includes the auxiliary storage device 921 and memory 922. The auxiliary storage device 921 may specifically be a read only memory (ROM), flash memory, or hard disk drive (HDD). The memory 922 may specifically be a random access memory (RAM). In the present embodiment, the storage unit 170 is implemented by the auxiliary storage device 921. Incidentally, the storage unit 170 may be implemented by the memory 922 or by the auxiliary storage device 921 and memory 922. A method to implement the storage unit 170 is arbitrary.

The input device 930 is an input instrument such as a mouse, keyboard, or touch panel. Incidentally, the design support device 100 may include an input interface that is a port to be connected to an input instrument such as a mouse, keyboard, or touch panel. The input interface may specifically be a universal serial bus (USB) terminal. Incidentally, the input interface may be a port to be connected to a local area network (LAN).

The output device 940 is a display instrument such as a display or an output instrument such as a printer. The output device 940 displays/outputs a high-order language description or RTL after high-order synthesis. Incidentally, the design support device 100 may include an output interface that is a port to be connected to a cable of a display instrument such as a display. The output interface may specifically be a USB terminal or a high definition multimedia interface (HDMI, registered trademark) terminal. The display may specifically be a liquid crystal display (LCD).

The auxiliary storage device 921 stores a program to implement the function of the “unit”. This program is loaded to the memory 922, read by the processor 910, and executed by the processor 910. The auxiliary storage device 921 also stores an operating system (OS). At least a part of the OS is loaded to the memory 922. The processor 910 executes the program to implement the function of the “unit” while executing the OS.

The design support device 100 may include only a single processor 910 or a plurality of processors 910. The plurality of processors 910 may execute the program to implement the function of the “unit” in cooperation.

Information, data, a signal value, and variable value showing a result of processing by the function of the “unit” are stored in the auxiliary storage device 921, memory 922, or a register or cache memory in the processor 910. Incidentally, in FIG. 1, an arrow connecting each of the units and the storage unit 170 represents that each of the units stores a result of processing in the storage unit 170 or that each of the units reads information from the storage unit 170. Furthermore, an arrow connecting each of the units represents a flow of control.

The program to implement the function of the “unit” may be stored in a portable storage medium such as a magnetic disc, flexible disk, optical disc, compact disc, Blu-ray (registered trademark) disc, or digital versatile disc (DVD). Incidentally, a program to implement the function of the “unit” may also be referred to as a design support program. The design support program implements the function described as the “unit”. Moreover, an object called a design support program product is a storage medium or storage device storing the design support program and is loaded with a computer-readable program regardless of a type of appearance thereof.

***Description of Operations***

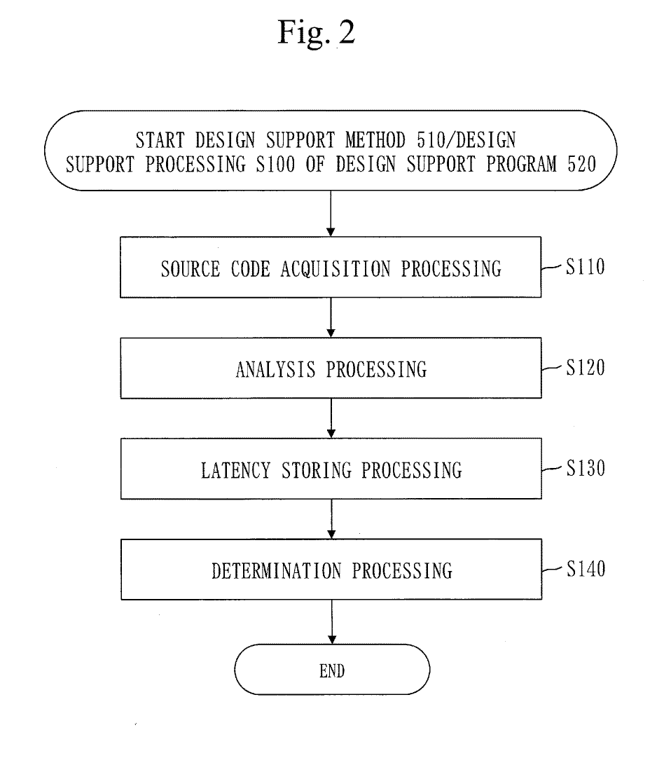

Operations of the design support device 100 of the present embodiment will be described. An outline of a design support method 510 of the design support device 100 and design support processing S100 by a design support program 520 of the present embodiment will be described with FIG. 2. The design support processing S100 includes source code acquisition processing S110, analysis processing S120, latency storing processing S130, and determination processing S140.

In the source code acquisition processing S110, the source code acquisition unit 110 fetches source code 180 stored in the storage unit 170. The source code 180 is specifically a source code describing operations of a circuit using a high-order language such as the C language, C++ language, or SystemC language. The source code 180 is input by a user via the input device 930 and stored in the storage unit 170.

In the analysis processing S120, the analysis unit 120 extracts, from the source code 180, an operation expression having the number of loops less than or equal to the number threshold 172. The analysis unit 120 outputs the extracted operation expression as extracted operation expression 181. The analysis processing S120 will be described in detail later.

In the latency storing processing S130, the high-order synthesis unit 140 converts the extracted operation expression 181 output in the analysis processing S120 into a converted operation expression in a hardware description language and outputs latency of the converted operation expression as operation expression latency 183. The latency storage unit 182 stores, in the storage unit 170, the operation expression latency 183 of the converted operation expression converted into the hardware description language from the extracted operation expression 181. The latency storing processing S130 will be described in detail later.

In the determination processing S140, the determination unit 150 outputs the extracted operation expression 181 as the tabulating operation expression 185 when the operation expression latency 183 is more than or equal to the latency threshold 176. The determination processing S140 will be described in detail later.

Incidentally, the analysis processing S120, latency storing processing S130, and determination processing S140 are executed on each statement of the source code 180 fetched in the source code acquisition processing S110.

<About Analysis Processing S120>

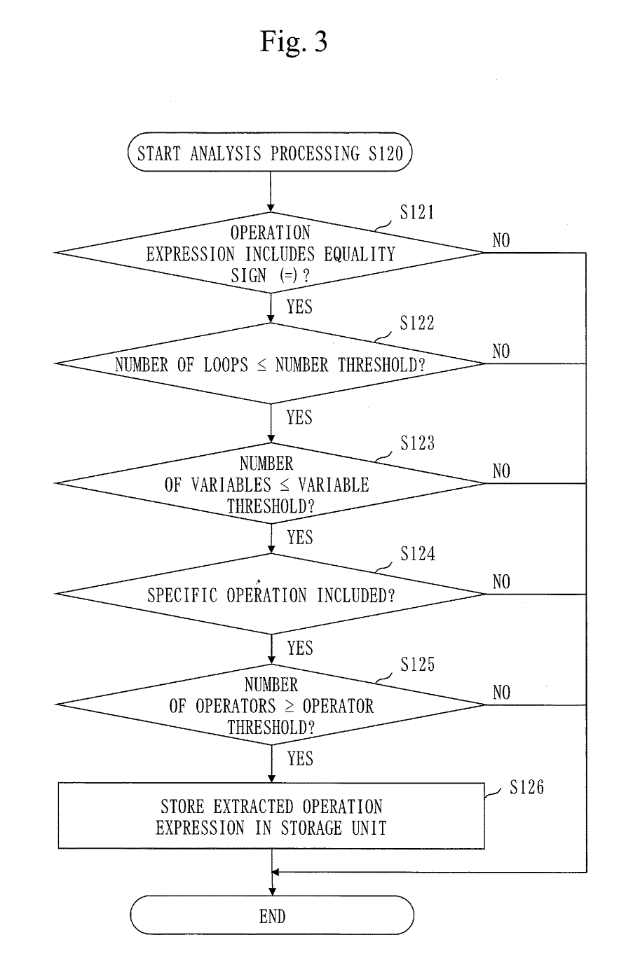

The analysis processing S120 of the present embodiment will be described with FIG. 3. In step S121, the operation expression analysis unit 121 in the analysis unit 120 analyzes statements of the source code 180 and determines whether an operation expression including an equality sign (=) is included. The operation expression analysis unit 121 proceeds to step S122 when a statement includes an operation expression including an equality sign. The operation expression analysis unit 121 terminates the processing when a statement does not include an operation expression including an equality sign.

Next, in step S122, the loop analysis unit 122 in the analysis unit 120 analyzes the number of loops in the operation expression having been determined as the operation expression including an equality sign by the operation expression analysis unit 121. The loop analysis unit 122 is also referred to as a for loop analysis unit. Specifically, the loop analysis unit 122 compares the number of loops in the operation expression and the number threshold 172 stored in the storage unit 170 and thereby determines whether the number of loops is less than or equal to the number threshold 172. The loop analysis unit 122 proceeds to step S123 when the number of loops is less than or equal to the number threshold 172. The loop analysis unit 122 terminates the processing when the number of loops is not less than or equal to the number threshold 172.

That is, in step S121 and step S123, the analysis unit 120 extracts, from the source code 180, an operation expression having the number of loops less than or equal to the number threshold. Incidentally, the loop analysis unit 122 may analyze the number of loops of an operation expression and thereby determine the size of a table when the operation expression is tabulated. In this case, the number of rows of a table is stored in the storage unit 170 and when the size of the table of the operation expression (the number of loops) is less than or equal to the number of rows, the processing proceeds to step S123. The storage unit 170 also stores in advance the number threshold 172 input by a user via the input device 930. The number threshold 172 is a parameter that can be specified by a user.

Next, in step S123, the variable analysis unit 123 in the analysis unit 120 analyzes the number of variables in the operation expression. Specifically, the variable analysis unit 123 compares the number of variables in the operation expression and the variable threshold 173 stored in the storage unit 170 and thereby determines whether the number of variables in the operation expression is less than or equal to the variable threshold 173. The variable analysis unit 123 proceeds to step S124 when the number of variables in the operation expression is less than or equal to the variable threshold 173. The variable analysis unit 123 terminates the processing when the number of variables in the operation expression is not less than or equal to the variable threshold 173. In a specific example where the variable threshold 173 is 1, the variable analysis unit 123 extracts an operation expression where the number of variables is 1 from the operation expression extracted by the loop analysis unit 122. Note that the variable threshold 173 is not limited to 1. The storage unit 170 stores in advance the variable threshold 173 input by a user via the input device 930. The variable threshold 173 is a parameter that can be specified by a user.

Next, in step S124, the specific operation analysis unit 124 in the analysis unit 120 analyzes the type of operation included in the operation expression. Specifically, the specific operation analysis unit 124 compares an operation included in the operation expression and the specific operation 174 stored in the storage unit 170. As the specific operation 174, for example, types of operations such as a square root or exponential function are set. The specific operation analysis unit 124 determines whether the operation expression includes the specific operation 174. The specific operation analysis unit 124 proceeds to step S125 when the operation expression includes the specific operation 174. The specific operation analysis unit 124 terminates the processing when the operation expression does not include the specific operation 174. Specifically, the specific operation analysis unit 124 determines, on the operation expression determined as having one variable by the variable analysis unit 123, whether the specific operation 174 is included. The storage unit 170 stores in advance the specific operation 174 input by a user via the input device 930. The specific operation 174 is a parameter that can be specified by a user.

Next, in step S125, the operator analysis unit 125 in the analysis unit 120 analyzes the number of operators included in the operation expression. Specifically, the operator analysis unit 125 compares the number of operators included in the operation expression and the operator threshold 175 stored in the storage unit 170. The operator analysis unit 125 determines whether the number of operators included in the operation expression is more than or equal to the operator threshold 175. The operator analysis unit 125 proceeds to step S126 when the number of operators included in the operation expression is more than or equal to the operator threshold 175. The operator analysis unit 125 terminates the processing when the number of operators included in the operation expression is not more than or equal to the operator threshold 175. In a specific example where the operator threshold 175 is 5, the operator analysis unit 125 determines, on the operation expression determined as including the specific operation 174 by the specific operation analysis unit 124, whether the number of operators is five or more. Note that the operator threshold 175 is not limited to 5. The storage unit 170 stores in advance the operator threshold 175 input by a user via the input device 930. The operator threshold 175 is a parameter that can be specified by a user.

In step S126, the operator analysis unit 125 in the analysis unit 120 outputs, as the extracted operation expression 181, the operation expression where the number of operators is determined as more than or equal to the operator threshold 175. That is, the analysis unit 120 extracts the operation expression where an equality sign is included, the number of loops is less than or equal to the number threshold 172, the number of variables is less than or equal to variable threshold 173, the specific operation 174 is included, and the number of operators is more than or equal to the operator threshold 175 and outputs as the extracted operation expression 181. Furthermore, the extraction result holding unit 130 stores the extracted operation expression 181 output from the analysis unit 120 in the storage unit 170.

The above is the descriptions on the analysis processing S120. The analysis processing S120 allows for extracting, as the extracted operation expression 181, a candidate operation expression suitable for tabulation.

<About Latency Storing Processing S130>

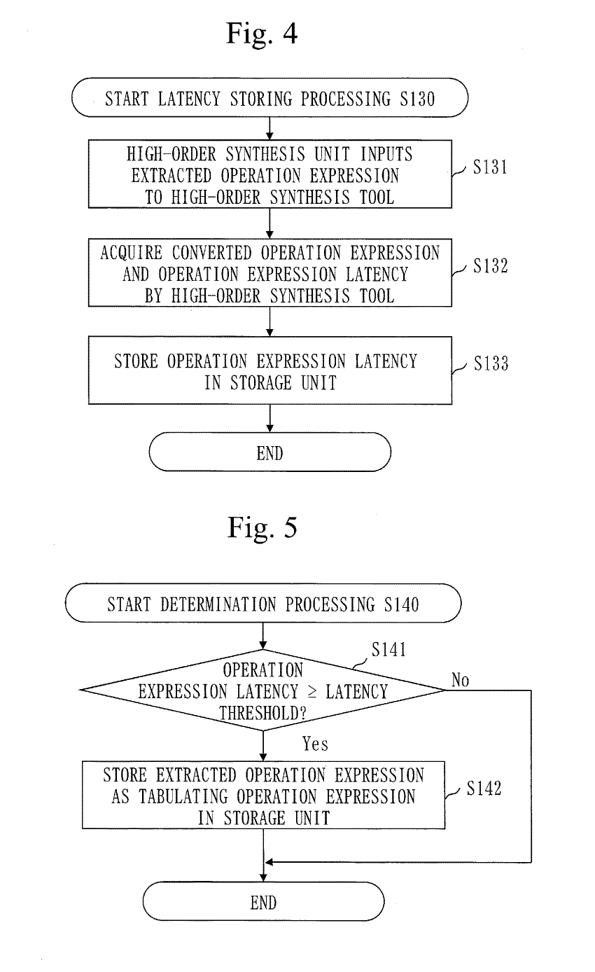

The latency storing processing S130 of the present embodiment will be described with FIG. 4. In step S131, the high-order synthesis unit 140 reads the extracted operation expression 181 stored in the storage unit 170 in the analysis processing S120. The high-order synthesis unit 140 converts the extracted operation expression 181 described in a high-order language into a hardware description language. Specifically, the high-order synthesis unit 140 inputs the extracted operation expression 181 to a high-order synthesis tool and thereby converts the extracted operation expression 181 into the hardware description language. In step S132, the high-order synthesis unit 140 outputs, as the operation expression latency 183, latency of a converted operation expression 810 described in the hardware description language. The high-order synthesis unit 140 outputs the converted operation expression 810 and operation expression latency 183 as latency information. Specifically, the high-order synthesis unit 140 inputs the extracted operation expression 181 to the high-order synthesis tool and outputs the converted operation expression 810 describing the extracted operation expression 181 in the hardware description language and the operation expression latency 183 that is the latency of the converted operation expression 810. In step S133, the latency storage unit 182 stores, in the storage unit 170, the operation expression latency 183 of the converted operation expression 810 where the extracted operation expression 181 is converted into the hardware description language.

The above is the descriptions on the latency storing processing S130. The latency storing processing S130 allows for outputting, as the operation expression latency 183, latency of the extracted operation expression 181 that is a candidate operation expression suitable for tabulation.

<About Determination Processing S140>

The determination processing S140 of the present embodiment will be described with FIG. 5. In step S141, the determination unit 150 reads the operation expression latency 183 and latency threshold 176 stored in the storage unit 170 and compares the operation expression latency 183 and latency threshold 176. When the operation expression latency 183 is more than or equal to the latency threshold 176, the processing proceeds to step S142. In step S142, the determination unit 150 outputs the extracted operation expression 181 as the tabulating operation expression 185. That is, the determination unit 150 stores the extracted operation expression 181 as the tabulating operation expression 185 in the storage unit 170. When the operation expression latency 183 is less than the latency threshold 176, the processing is terminated.

The storage unit 170 stores in advance the latency threshold 176 input by a user via the input device 930. The latency threshold 176 is a parameter that can be specified by a user.

The above is the descriptions on the determination processing S140. As described above, the design support processing S100 allows for extracting, as the tabulating operation expression 185, an operation expression where the operation expression latency 183 is more than or equal to the latency threshold 176 from the extracted operation expression 181 suitable for tabulation. The tabulating operation expression 185 is a determination result 184 of the determination processing S140 by the determination unit 150.

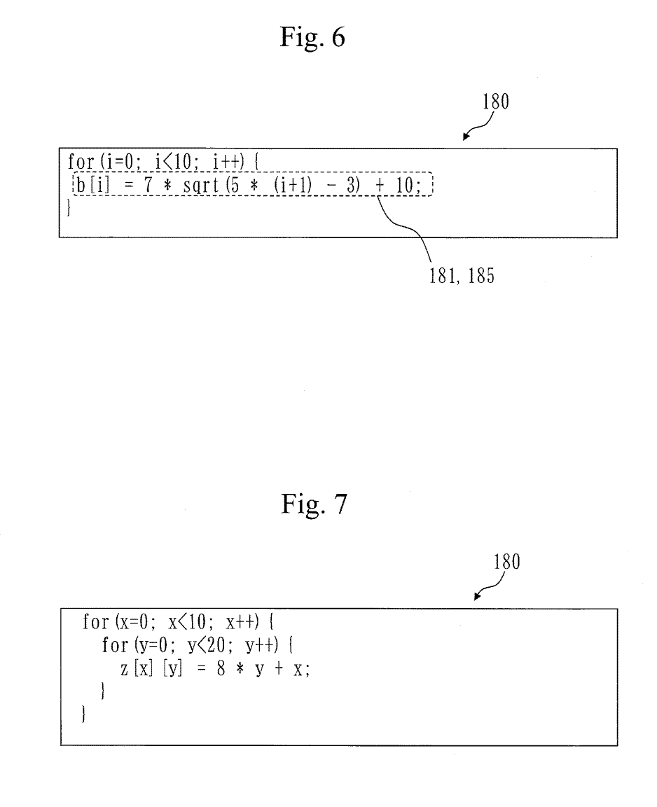

Next, the design support processing S100 by the design support device 100 of the present embodiment will be described with specific examples in FIGS. 6 and 7. FIGS. 6 and 7 show specific examples of the source code 180. Here, an assumption is made that number threshold 172=30, variable threshold 173=1, and operator threshold 175=5.

First, the analysis processing S120 in FIG. 3 will be described with an exemplary source code in FIG. 6. In step S121, the operation expression analysis unit 121 extracts an operation expression of b[i]=7*sqrt(5*(i+1)−3)+10; as an operation expression including an equality sign from the source code in FIG. 6. The processing proceeds to step S122. In step S122, the loop analysis unit 122 analyzes the number of loops in the operation expression and determines the number of loops (that is, a table size) as 10. The loop analysis unit 122 determines that an inequality of the number of loops≦number threshold 172 is satisfied since the number of loops in the operation expression is 10 and the number threshold 172 is 30. The processing proceeds to step S123. In step S123, the variable analysis unit 123 analyzes the number of variables in the operation expression and determines the number of variables (i in the operation expression corresponds thereto) as 1. The variable analysis unit 123 determines that an inequality of the number of variables≦variable threshold 173 is satisfied since the number of variables of the operation expression is 1 and the variable threshold 173 is 1. The processing proceeds to step S124. In step S124, the specific operation analysis unit 124 analyzes the type of operation included in the operation expression and determines that the operation expression includes the specific operation 174 (here, sqrt corresponds thereto). The processing proceeds to step S125 since the specific operation analysis unit 124 has determined that the operation expression includes the specific operation sqrt. In step S125, the operator analysis unit 125 analyzes operators in the operation expression and determines the number of operators as five (two multiplications, one subtraction, one addition, and one square root). The operator analysis unit 125 determines that an inequality of the number of operators≧operator threshold 175 is satisfied since the number of operators is 5 and the operator threshold 175 is 5. The operator analysis unit 125 outputs this operation expression of b[i]=7*sqrt(5*(i+1)−3)+10; as the extracted operation expression 181.

Next, the operation expression latency 183 is assumed as 10 as a result of high-order synthesis on the extracted operation expression 181 (b[i]=7*sqrt(5*(i+1)−3)+10); by the latency storing processing S130 in FIG. 4.

Next, whether the extracted operation expression 181 is employed as the tabulating operation expression 185, which is subjected to tabulation by the determination processing S140 in FIG. 5, is determined Here, the latency threshold 176 is assumed as 5. In step S141, the determination unit 150 determines that an inequality of operation expression latency 183≧latency threshold 176 is satisfied since the operation expression latency 183 is 10 and the latency threshold 176 is 5. The processing proceeds to step S142. In step S142, the determination unit 150 determines that the extracted operation expression 181 (b[i]=7*sqrt(5*(i+1)−3)+10); is the operation expression to be tabulated and stores the extracted operation expression 181 in the storage unit 170 as the tabulating operation expression 185.

Next, the analysis processing S120 in FIG. 3 will be described with an exemplary source code in FIG. 7. In step S121, the operation expression analysis unit 121 extracts an operation expression of z[x][y]=8*y+x; as an operation expression including an equality sign from the source code in FIG. 7. The processing proceeds to step S122. In step S122, the loop analysis unit 122 analyzes the number of loops in the operation expression and determines the number of loops (that is, a table size) as 200. The loop analysis unit 122 determines that the inequality of the number of loops≦number threshold 172 is not satisfied since the number of loops in the operation expression is 200 and the number threshold 172 is 30 and terminates the processing. In this manner, an operation expression having too many loops is excluded from candidate operation expressions for tabulation since no reduction of latency through tabulation is expected.

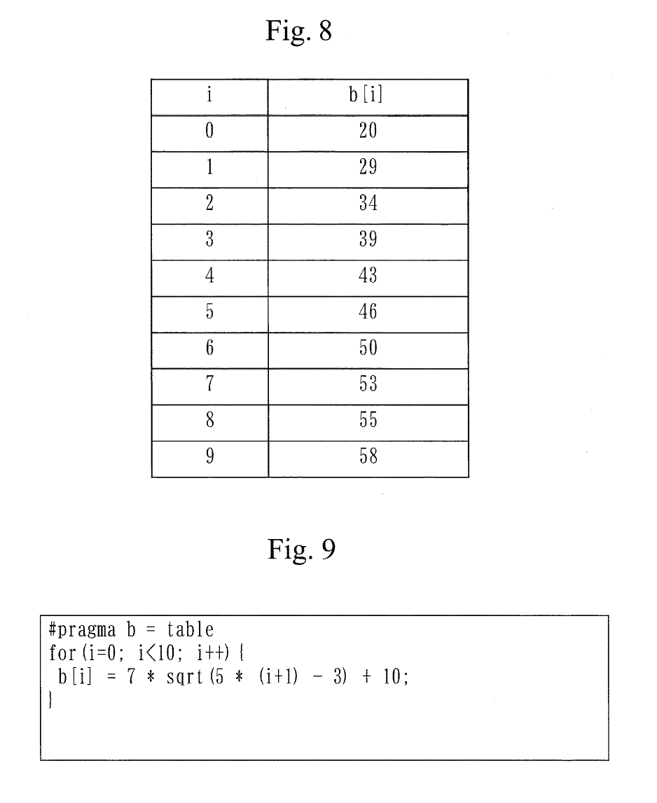

FIG. 8 is a diagram showing a tabulated tabulating operation expression 185 of the present embodiment. In FIG. 8, the tabulating operation expression 185 (b[i]=7*sqrt(5*(i+1)−3)+10); included in the source code in FIG. 6 is tabulated. With the tabulating operation expression 185 (b[i]=7*sqrt(5*(i+1)−3)+10), calculating an output value b[i] of a value (any integer of 0 to 9) that a variable i may take provides the table shown in FIG. 8.

When the design support device 100 extracts the tabulating operation expression 185, adding a pragma or attribute to the tabulating operation expression 185 in a description in the high-order language allows for tabulating the RTL after high-order synthesis. FIG. 9 is a diagram showing an exemplary pragma description upon tabulating the tabulating operation expression 185 of the present embodiment. In FIG. 9, “#pragma b=table” is the pragma.

The above is the descriptions on the processing, in circuit designing, to extract the tabulating operation expression 185 of which latency can be effectively reduced through tabulation and to tabulate the extracted tabulating operation expression 185.

***Another Configuration***

In the present embodiment, the processing by the operation expression analysis unit 121, processing by the loop analysis unit 122, processing by the variable analysis unit 123, processing by the specific operation analysis unit 124, and processing by the operator analysis unit 125 are performed in the order mentioned; however, the order of processing is not limited to the above order.

Furthermore in the analysis processing S120 of the present embodiment, all of the processing by the operation expression analysis unit 121, processing by the loop analysis unit 122, processing by the variable analysis unit 123, processing by the specific operation analysis unit 124, and processing by the operator analysis unit 125 are performed; however, it is only required to execute at least the processing by the operation expression analysis unit 121 and processing by the loop analysis unit 122. Hereinafter, variations of the analysis processing S120 by the analysis unit 120 will be described.

The analysis unit 120 outputs an operation expression where the number of loops is less than or equal to the number threshold 172 as the extracted operation expression 181. That is, the analysis unit 120 executes the processing by the operation expression analysis unit 121 and processing by the loop analysis unit 122 in the analysis processing S120.

The analysis unit 120 further extracts an operation expression where the number of loops is less than or equal to the number threshold 172 and outputs this operation expression as the extracted operation expression 181 when the number of variables included in the operation expression is less than or equal to the variable threshold 173. That is, the analysis unit 120 executes the processing by the operation expression analysis unit 121, processing by the loop analysis unit 122, and processing by the variable analysis unit 123 in the analysis processing S120.

Alternatively, the analysis unit 120 extracts an operation expression where the number of loops is less than or equal to the number threshold 172 and outputs this operation expression as the extracted operation expression 181 when the number of variables included in the operation expression is less than or equal to the variable threshold 173 and this operation expression includes a specific operation. That is, the analysis unit 120 executes the processing by the operation expression analysis unit 121, processing by the loop analysis unit 122, processing by the variable analysis unit 123, and processing by the specific operation analysis unit 124 in the analysis processing S120.

Further alternatively, the analysis unit 120 extracts an operation expression where the number of loops is less than or equal to the number threshold 172 and outputs this operation expression as the extracted operation expression 181 when the number of variables included in the operation expression is less than or equal to the variable threshold 173 and the number of operators included in this operation expression is more than or equal to the operator threshold 175. That is, the analysis unit 120 executes the processing by the operation expression analysis unit 121, processing by the loop analysis unit 122, and processing by the operator analysis unit 125 in the analysis processing S120.

Alternatively, the analysis unit 120 may execute, in the analysis processing S120, the processing by the variable analysis unit 123, processing by the specific operation analysis unit 124, or processing by the operator analysis unit 125 in any combination thereof in addition to the processing by the operation expression analysis unit 121 and processing by the loop analysis unit 122.

Alternatively, the design support device 100 may include a communication device and receive the number threshold 172, variable threshold 173, specific operation 174, operator threshold 175, and latency threshold 176 via the communication device from a user. Furthermore, the design support device 100 may transmit the determination result 184 via the communication device. In this case, the communication device includes a receiver and a transmitter. Specifically, the communication device is a communication chip or a network interface card (NIC). The communication device functions as a communication unit to communicate data. The receiver functions as a receiving unit to receive data while the transmitter functions as a transmitting unit to transmit data.

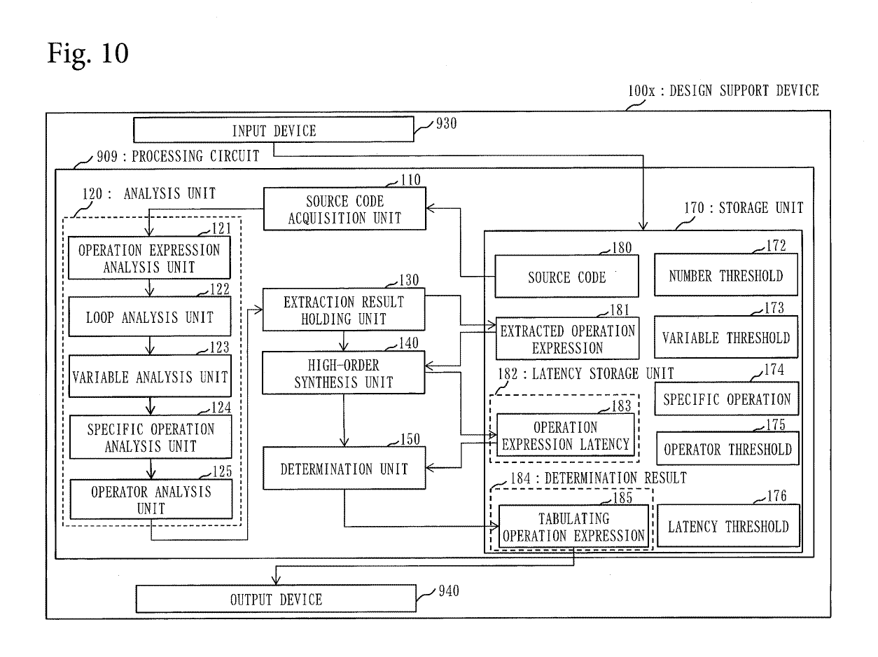

In the present embodiment, the functions of the “units” of the design support device 100 are implemented by software; however, in a variation, the functions of the “units” of the design support device 100 may be implemented by hardware. A configuration of a design support device 100x of the variation of the present embodiment will be described with FIG. 10. As shown in FIG. 10, the design support device 100x includes hardware such as a processing circuit 909, input device 930, and output device 940.

The processing circuit 909 is a dedicated electronic circuit to implement the aforementioned functions of the “units” and the storage unit 170. The processing circuit 909 may specifically be a single circuit, composite circuit, programmed processor, parallel-programmed processor, logic IC, gate array (GA), application specific integrated circuit (ASIC), or field-programmable gate array (FPGA).

The functions of the “units” may be implemented by one processing circuit 909 or implemented by a plurality of processing circuits 909 in a distributed manner.

As another variation, the functions of the design support device 100 may be implemented by a combination of software and hardware. That is, a part of the functions of the design support device 100 may be implemented by dedicated hardware while the rest of the functions are implemented by software.

The processor 910, storage device 920, and processing circuit 909 are collectively referred to as “processing circuitry”. That is, regardless of which configuration shown in FIGS. 1 and 10 a configuration of the design support device 100 is, the functions of the “units” and storage unit 170 are implemented by the processing circuitry.

The “unit” may be replaced with “step”, “procedure”, or “processing”. Alternatively, the functions of the “units” may be implemented by firmware.

***Explanation on Effects of the Present Embodiment***

In the above manner, the design support device 100 of the present embodiment allows for analyzing the number of loops of an operation expression and extracting an operation expression with large latency, thereby allowing for accurately extracting a tabulating operation expression of which latency can be effectively reduced through tabulation. That is, according to the design support device 100 of the present embodiment, an operation expression not suitable for tabulation due to too many loops can be excluded from the tabulating operation expression 185, thereby allowing for accurately extracting an operation expression suitable for tabulation.

Moreover, the design support device 100 of the present embodiment considers the number of variables in an operation expression and thus allows for accurately extracting a tabulating operation expression. That is, according to the design support device 100 of the present embodiment, an operation expression not suitable for tabulation due to too many variables can be excluded from the tabulating operation expression 185, thereby allowing for accurately extracting an operation expression suitable for tabulation.

Furthermore, the design support device 100 of the present embodiment considers the type of operation included in an operation expression and thus allows for further accurately extracting a tabulating operation expression. That is, according to the design support device 100 of the present embodiment, an operation expression where reduction of latency through tabulation cannot be expected since a specific operation is not included can be excluded from the tabulating operation expression 185, thereby allowing for accurately extracting an operation expression suitable for tabulation.

Furthermore, the design support device 100 of the present embodiment considers the number of operators included in an operation expression and thus allows for further accurately extracting a tabulating operation expression. That is, according to the design support device 100 of the present embodiment, an operation expression where reduction of latency through tabulation cannot be expected since the number of operators is small can be excluded from the tabulating operation expression 185, thereby allowing for accurately extracting an operation expression suitable for tabulation.

Also, according to the design support device 100 of the present embodiment, the number threshold 172, variable threshold 173, specific operation 174, operator threshold 175, and latency threshold 176 are parameters that can be specified by a user. Therefore, a configuration can be flexibly modified depending on a size of a circuit to be designed.

The embodiments of the present invention have been described above. Of those described as “units” in the descriptions of the embodiments, any one thereof may be employed alone or an arbitrary combination of some thereof may be employed. That is, a functional block of the design support device is arbitrary as long as the functions described in the above embodiment can be implemented. A design support device may be configured by any combination of such functional blocks or by an arbitrary block configuration. Alternatively, a design support device may not be a single device but may be a design support system configured by a plurality of devices.

Alternatively, a plurality of parts of the present embodiment may be implemented in combination. Alternatively, the present embodiment may be implemented partially. Alternatively, the present embodiment may be implemented wholly or partially in any combination thereof. Incidentally, the above embodiments are examples that are essentially preferable and thus are not intended to limit the scope of the present invention, an application thereof, or usage thereof and may include various variations as necessary.

Numerous additional modifications and variations are possible in light of the above teachings. It is therefore to be understood that, within the scope of the appended claims, the disclosure of this patent specification may be practiced otherwise than as specifically described herein.

### REFERENCE SIGNS LIST

100, 100x: design support device, 110: source code acquisition unit, 120: analysis unit, 130: extraction result holding unit, 140: high-order synthesis unit, 150: determination unit, 170: storage unit, 121: operation expression analysis unit, 122: loop analysis unit, 123: variable analysis unit, 124: specific operation analysis unit, 125: operator analysis unit, 172: number threshold, 173: variable threshold, 174: specific operation, 175: operator threshold, 176: latency threshold, 180: source code, 181: extracted operation expression, 182: latency storage unit, 183: operation expression latency, 184: determination result, 185: tabulating operation expression, 510: design support method, 520: design support program, 909: processing circuit, 910: processor, 920: storage device, 921: auxiliary storage device, 922: memory, 930: input device, 940: output device, S100: design support processing, S110: source code acquisition processing, S120: analysis processing, S130: latency storing processing, and S140: determination processing

1. A design support device comprising:
an analysis unit to extract an operation expression where a number of loops is less than or equal to a number threshold from a source code and to output the operation expression as an extracted operation expression;
a latency storage unit to store, as operation expression latency in a storage unit, latency of a converted operation expression converted into a hardware description language from the extracted operation expression output from the analysis unit; and
a determination unit to output the extracted operation expression as a determination result when the operation expression latency is more than or equal to a latency threshold.

2. The design support device according to claim 1,
wherein the analysis unit outputs the operation expression as the extracted operation expression when a number of variables included in the operation expression is less than or equal to a variable threshold.

3. The design support device according to claim 1,
wherein the analysis unit outputs the operation expression as the extracted operation expression when the operation expression includes a specific operation.

4. The design support device according to claim 1,
wherein the analysis unit outputs the operation expression as the extracted operation expression when a number of operators included in the operation expression is more than or equal to an operator threshold.

5. The design support device according to claim 1, further comprising an input device,
wherein the storage unit stores the number threshold input via the input device as well as the latency threshold input via the input device.

6. The design support device according to claim 2, further comprising an input device,
wherein the storage unit stores the variable threshold input via the input device.

7. The design support device according to claim 3, further comprising an input device,
wherein the storage unit stores the specific operation input via the input device.

8. The design support device according to claim 4, further comprising an input device,
wherein the storage unit stores the operator threshold input via the input device.

9. A design support method comprising:
extracting, by an analysis unit, an operation expression where a number of loops is less than or equal to a number threshold from a source code and outputting the operation expression as an extracted operation expression;
retaining, by a latency storage unit, as operation expression latency in a storage unit, latency of a converted operation expression converted into a hardware description language from the extracted operation expression output from the analysis unit; and
outputting, by a determination unit, the extracted operation expression as a determination result when the operation expression latency is more than or equal to a latency threshold.

10. A non-transitory computer readable recording medium which records a design support program to cause a computer to execute the processing of:
analysis processing to extract an operation expression where a number of loops is less than or equal to a number threshold from a source code and to output the operation expression as an extracted operation expression;
latency storing processing to store, as operation expression latency in a storage unit, latency of a converted operation expression converted into a hardware description language from the extracted operation expression output by the analysis processing; and
determination processing to output the extracted operation expression as a determination result when the operation expression latency is more than or equal to a latency threshold.
